(19) United States
(12) Patent Application Publication
(10) Pub. No.: US 2025/0128397 A1
(43) Pub. Date: Apr. 24, 2025

(54) TOOL SUSPENDER

(71) Applicant: Signode Industrial Group LLC, Tampa, FL (US)

(72) Inventors: Kurt Bolliger, Ehrendingen (CH); Michael Andreas Wettstein, Lenzburg (CH)

(21) Appl. No.: 18/683,904

(22) PCT Filed: Sep. 6, 2022
(86) PCT No.: PCT/US2022/075961

§ 371 Date: Feb. 15, 2024

Related U.S. Application Data
(60) Provisional application No. 63/244,909, filed on Sep. 16, 2021.

(51) Int. Cl. B25H 1/00

(52) U.S. Cl. CPC B25H 1/0028

(57) ABSTRACT

A tool suspender (100) comprising: a first plate (200); a second plate (300); a gripping assembly (400) between the first plate (200) and the second plate (300) and comprising first and second jaws (410, 430) supported by the first and second plates (200, 300), the first jaw (410) movable between a first closed position and a first open position and the second jaw (430) moveable between a second closed position and a second open position; and a locking assembly (500) having a locked configuration in which the locking assembly (500) prevents the first and second jaws (410, 430) from moving from their closed positions to their open positions and an unlocked configuration in which the locking assembly (500) does not prevent the first and second jaws (410, 430) from moving from their closed positions to their open positions.

### PRIORITY

This application claims priority to and the benefit of U.S. Provisional Patent Application No. 63/244,909, filed Sep. 16, 2021, the entire contents of which is incorporated herein by reference.

### FIELD

The present disclosure relates to tool suspenders, and more particularly to tool suspenders configured to assist in suspending a tool when the tool in in use and when the tool is not in use.

### BACKGROUND

Industrial handheld tools can be labor intensive for an operator to use on a repeated basis. Even relatively light industrial tools, such as handheld battery-powered strapping tools, can become taxing to use in a repetitive manner, especially when an operator needs to frequently pick up and put down the tool to strap different loads.

To reduce the amount of labor needed to use these handheld tools, various tool suspension devices have been employed. These tool suspension devices can hold and maintain a tool in a suspended position above the floor and support the weight of the tool so an operator can use the tool without intensive labor and can release the tool into a suspended position when not in use.

### SUMMARY

Various embodiments of the present disclosure provide a tool suspender configured to releasably hold part of a tool-such as a handle of the tool—to help support the tool in a suspended position when the tool is in use and when the tool is not in use.

Various embodiments of the present disclosure provide a tool suspender including a first plate; a second plate; a gripping assembly between the first plate and the second plate and including first and second jaws supported by the first and second plates, the first jaw movable between a first closed position and a first open position and the second jaw moveable between a second closed position and a second open position; and a locking assembly having a locked configuration in which the locking assembly prevents the first and second jaws from moving from their closed positions to their open positions and an unlocked configuration in which the locking assembly does not prevent the first and second jaws from moving from their closed positions to their open positions.

### BRIEF DESCRIPTION OF THE FIGURES

FIG. 1 is a perspective view of one example embodiment of the tool suspender of the present disclosure with its locking assembly in its locked configuration and retaining position and the jaws of its gripping assembly in their respective closed positions.

FIG. 2 is a perspective view of the tool suspender of FIG. 1 with the locking assembly in its unlocked configuration and release position and the jaws of its gripping assembly in their respective open positions.

FIG. 3 is an exploded perspective view of the tool suspender of FIG. 1.

FIG. 4 is a perspective view of the locking assembly of the tool suspender of FIG. 1.

FIG. 5 is an exploded perspective view of the locking assembly of FIG. 4.

FIG. 6 is a partial cross-sectional perspective view of the tool suspender of FIG. 1 with the locking assembly in its locked configuration and retaining position.

FIG. 7 is a front elevational view of the tool suspender of FIG. 1 with the first plate removed, and the locking assembly in its the locked configuration and retaining position, and the jaws of the gripping assembly in their respective closed positions.

FIG. 8 is a front elevational view of the tool suspender of FIG. 1 with the first plate removed, the locking assembly in its unlocked configuration and release position, and the jaws of the gripping assembly in their respective open positions.

FIG. 9A is a perspective view of the tool suspender of FIG. 1 holding a handle of a strapping tool.

FIG. 9B is a side view corresponding to FIG. 9A.

FIG. 9C is a cross-sectional front elevational view of the tool suspender of FIG. 1 holding the handle of the strapping tool of FIGS. 9A and 9B.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

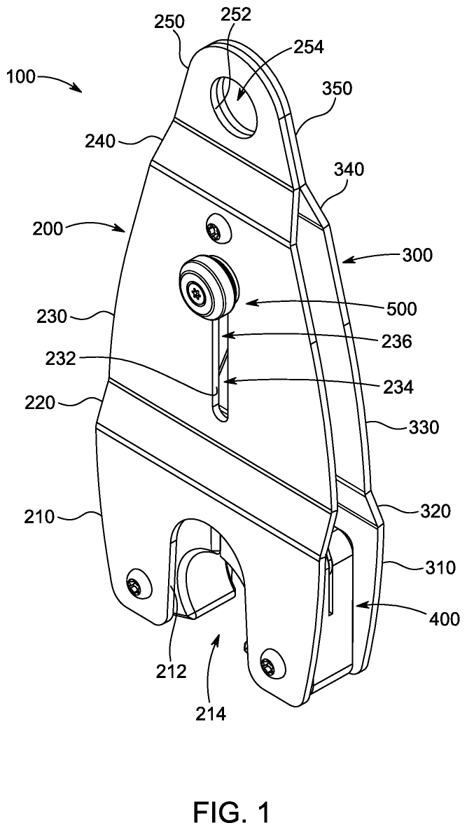

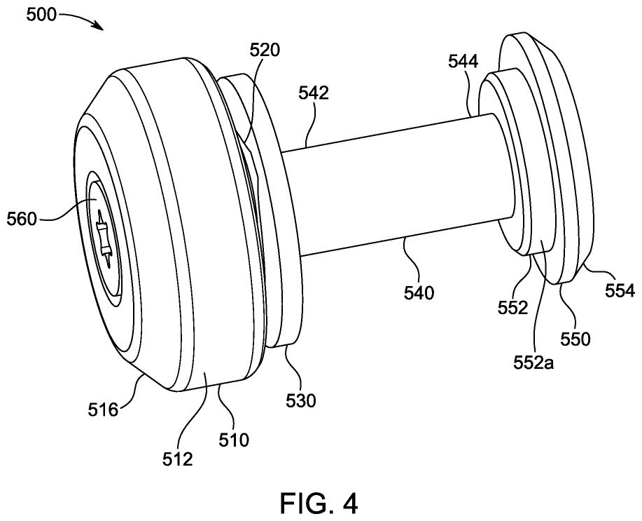

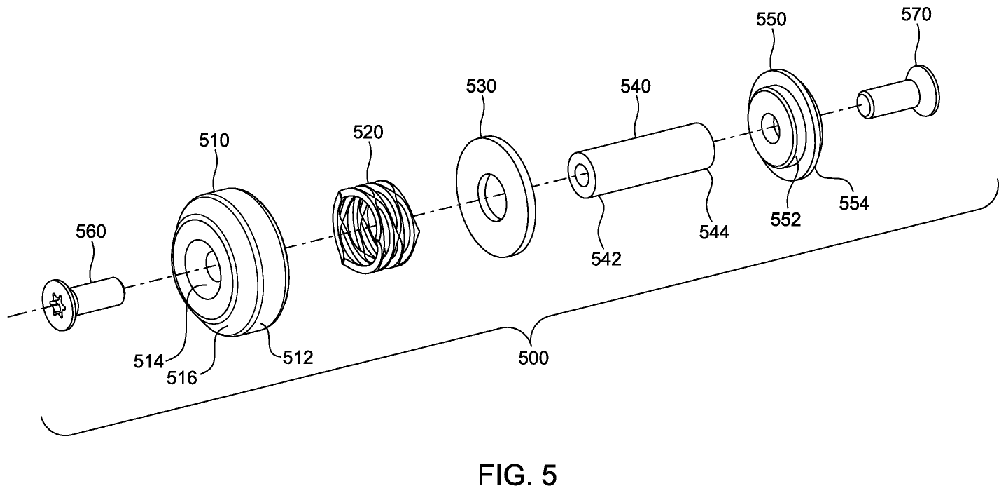

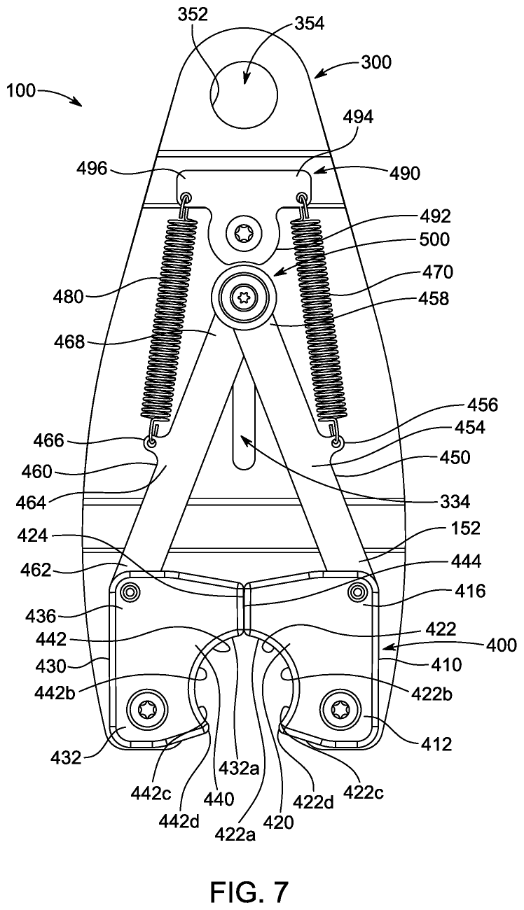

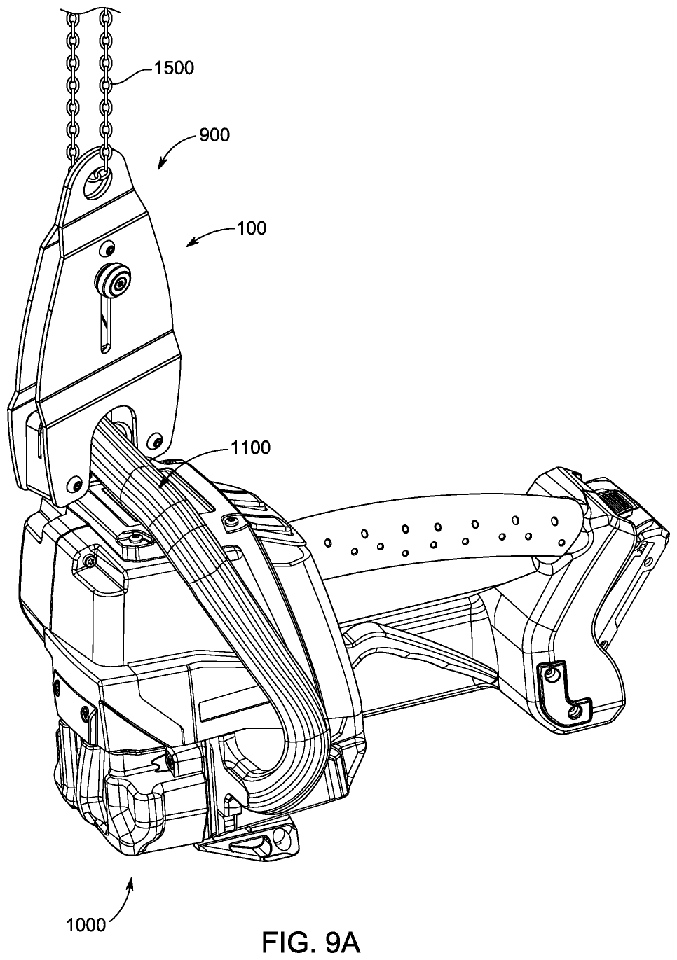

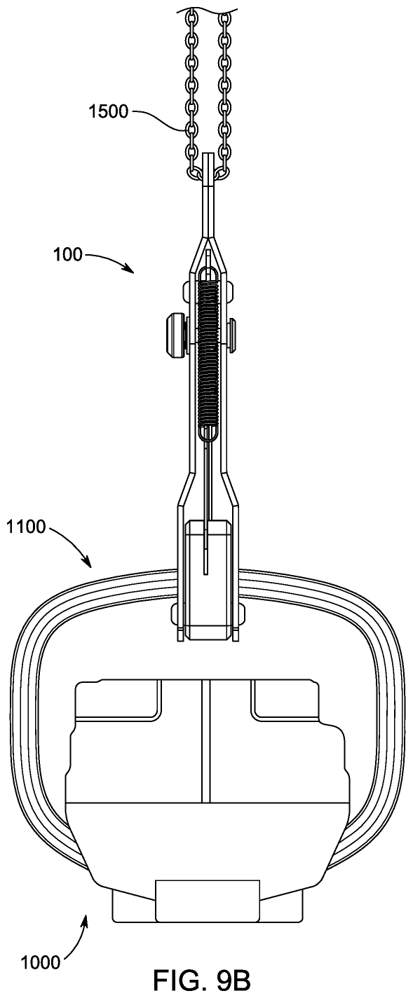

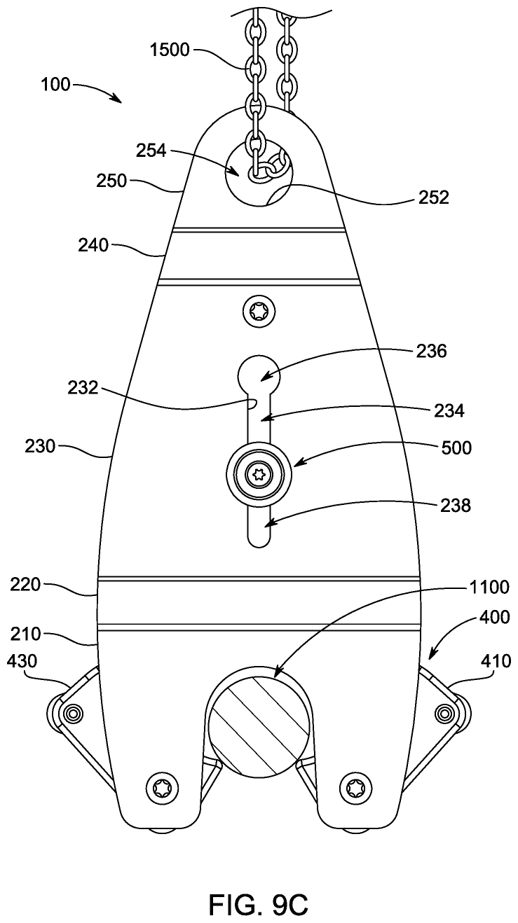

Various embodiments of the present disclosure provide a tool suspender configured to releasably hold part of a tool—such as a handle of the tool—to help support the tool is a suspended position when the tool is in use and when the tool is not in use. FIGS. 1-9C show one example embodiment of the tool suspender 100 of the present disclosure (sometimes referred to as the “suspender” in the Detailed Description for brevity) and the components thereof. The tool suspender 100 is configured to releasably hold part of a tool to help support the tool in a suspended position before, during, and after use of the tool. In this example embodiment, the tool suspender 100 is configured to releasably hold a handle 1100 of a strapping tool 1000 as shown in FIGS. 9A-9C. The tool suspender 100 is configured to be supported by a suitable suspension device, such as a chain 1500 shown in FIGS. 9A-9C, that is in turn attached to a counter-balanced articulating arm (not shown). The suspension device can be any suitable device and can be adjusted to move in one or more degrees of freedom.

The tool suspender 100 includes a first plate 200, a second plate 300, a gripping assembly 400, and a locking assembly 500. The first plate 200, the second plate 300, and the gripping assembly 400 are operable to releasably hold the handle 1100 of the tool 1000. The first plate 200 and the second plate 300 are sized and shaped to be held by a suspension member (such as the chain 1500) to support the tool suspender 100 and the tool 1000 in desired suspended positions during use of the tool 1000 and when the tool 1000 is not in use. The locking assembly 500 is manipulatable by the operator to lock the gripping assembly 400 to prevent the gripping assembly 400 from releasing the handle 1100 and to, when desired, unlock the gripping assembly 400 to enable the gripping assembly 400 to release the handle 1100.

More specifically, as best shown in FIGS. 1, 2, 3, 6, and 9C, the first plate 200 includes a lower section 210, a first connector section 220, a first central section 230, a second connector section 240, and an upper section 250. The lower section 210 includes an inverted U-shaped inner wall 212 that defines an inverted U-shaped handle-receiving slot 214. The lower section 210 also defines two fastener receiving bores 216 and 218 therethrough on opposite sides of the handle-receiving slot 214. The first connector section 220 extends upwardly and inwardly from the lower section 210 and connects the lower section 210 to the central section 230. The central section 230 includes a wall 232 that defines a pin-receiving slot 234. The pin-receiving slot 234 includes a circular locking section 236 and an elongated pin-travel lower section 238 extending from the locking section 236 toward the handle-receiving slot 214. The central section 230 also defines a fastener receiving bore 239 therethrough. The second connector section 240 extends upwardly and inwardly from the central section 230 and connects the central section 230 to the upper section 250. The upper section 250 includes a cylindrical wall 252 that defines a suspension-member-receiving opening 254.

Likewise, as best shown in FIGS. 1, 2, 6, 7, and 8, the second plate 300 includes a lower section 310, a first connector section 320, a first central section 330, a second connector section 340, and an upper section 350. The lower section 310 includes an inverted U-shaped inner wall 312 that defines an inverted U-shaped handle-receiving slot 324. The lower section 310 also defines two fastener receiving bores 316 and 318 therethrough on opposite sides of the handle-receiving slot 324. The first connector section 320 extends upwardly and inwardly from the lower section 310 and connects the lower section 310 to the central section 330. The central section 330 includes a wall 332 that defines a pin-receiving slot 334. The pin-receiving slot 334 includes a circular locking section 336 and an elongated pin-travel lower section 338 extending from the locking section 336 toward the handle-receiving slot 324. The central section 330 also defines a fastener receiving bore 339 therethrough. The second connector section 340 extends upwardly and inwardly from the central section 330 and connects the central section 330 to the upper section 350. The upper section 350 includes a cylindrical wall 352 that defines a suspension-member-receiving opening 354. Though the first and second plates 200 and 300 are identical in this example embodiment, they need not be in other embodiments.

In this example embodiment, the first and second plates 200 and 300 are attached back-to-back in a mirror-image configuration such that: the lower sections 210 and 310 are aligned, the first connector sections 220 and 320 are aligned, the central sections 230 and 330 are aligned, the second connector sections 240 and 340 are aligned, the upper sections 250 and 350 are aligned, the handle-receiving slots 214 and 324 are aligned to form a combined handle-receiving slot (that is wider than the tool handle to which the suspender 100 can be attached), the fastener-receiving openings 216 and 218 and 316 and 318 are respectively aligned (and sized and shaped to receive fasteners 429a, 429b, 449a, and 449b that hold the plates 200 and 300 together), the pin-receiving slots 234 and 334 are aligned, the fastener-receiving openings 239 and 339 are aligned (and sized and shaped to receive fasteners 499a and 499b that hold the plates 200 and 300 together), and the suspension-member-receiving openings 254 and 354 are aligned.

The gripping assembly 400 includes a first jaw 410, a second jaw 430, a first jaw actuator 450, a second jaw actuator 460, a first biasing member 470 (here an extension spring), a second biasing member 480 (here an extension spring), and a biasing-member mount 490.

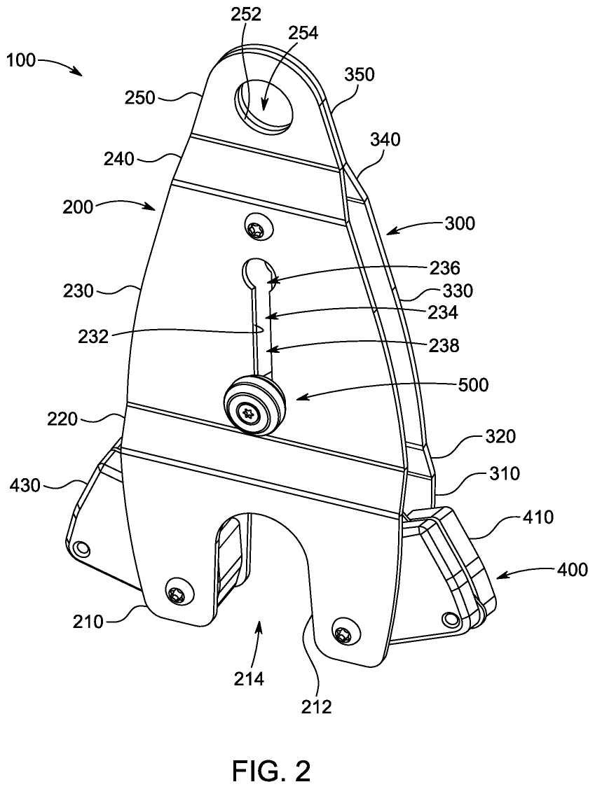

As best shown in FIGS. 2, 3, 7, and 8, the first jaw 410 includes a generally L-shaped body having a pivot section 412, a connection section 416, and a gripping section 420. The pivot section 412 defines a transversely extending bore 413 therethrough that is sized and shaped to receive a tubular pivot pin sleeve 428. The pivot section 412 is pivotally connected to the first section 210 of the first plate 200 and the first section 310 of the second plate 200 by the pivot pin sleeve 428 and suitable fasteners 429a and 429b. The connection section 416 defines a transversely extending bore 417 therethrough that is sized and shaped to receive a connection pin 459. The connection section 416 is pivotally connected to the first jaw actuator 450 by the connection pin 459. The gripping section 420 includes a curved inner surface 422 sized and shaped to engage the tool handle 1100 of the strapping tool 1000. The curved inner surface 422 has a curved upper area 422a sized and shaped to engage a top surface of the tool handle 1100, a curved central area 422b sized and shaped to engage a first side surface of the tool handle 1100, and a curved bottom area 422c sized and shaped to engage a bottom surface of the tool handle 1100. The bottom area 422c has a pointed bottom tooth 422d sized and shaped to engage a bottom surface of the tool handle 1100. The bottom area 422c including the bottom tooth 422d is sized and shaped to engage the tool handle 1100 and carry the tool's weight. The weight force applied to the bottom area 422c causes a torque in counterclockwise direction to 410 (vice versa on 430). This torque causes the jaws to pivot in opposing directions approaching each other and by doing that applying a force to the handle 1100 which holds it firmly. It should be appreciated that the weight of the tool creates a force that is then used to cause a tight grip to the handle of the tool. The surfaces areas 422a, 422b, and 422c of the first jaw 410 are each curved to accommodate and mate with a cylindrical tool handle; however, one or more of the surfaces can be alternatively sized and shaped to accommodate and mate with a tool handle have an alternatively shaped tool handle. The gripping section 420 also includes a stop surface 424 sized and shaped to engage the second jaw 430.

Likewise, as also best shown in FIGS. 2, 3, 7, and 8, the second jaw 430 includes an upside down generally L-shaped body having a pivot section 432, a connection section 436, and a gripping section 440. The pivot section 432 defines a transversely extending opening 433 sized and shaped to receive a cylindrical tubular pivot pin sleeve 438. The pivot section 432 is pivotally connected to the first section 230 of the first plate 200 and the first section 310 of the second plate 200 by the pivot pin sleeve 438 and suitable fasteners 449a and 449b. The connection section 436 defines a transversely extending opening 437 sized and shaped to receive a connection pin 469. The connection section 436 is pivotally connected to the jaw actuator 460 by the connection pin 469. The gripping section 440 includes a curved inner surface 442 sized and shaped to engage a tool handle such as the example tool handle 1100 of the example strapping tool 1000 as shown in FIGS. 9A, 9B, and 9C. The curved inner surface 442 has a curved upper area 442a sized and shaped to engage a top surface of the tool handle 1100, a curved central area 442b sized and shaped to engage a second side surface of the tool handle 1100, and a curved bottom area 442c sized and shaped to engage a bottom surface of the tool handle 1100. The bottom area 442c including the bottom tooth 442d is sized and shaped to engage the tool handle 1100 and carry the tool's weight. The weight force applied to the bottom area 442c causes a torque in a clockwise direction to 430 (vice versa on 410). This torque causes the jaws to pivot in opposing directions approaching each other and by doing that applying a force to the handle 1100 which holds it firmly. The surfaces areas 442a, 442b, and 442c of the second jaw 430 are each curved to accommodate and mate with a cylindrical tool handle; however, one or more of the surfaces can be alternatively sized and shaped to accommodate and mate with a tool handle have an alternatively shaped tool handle. The gripping section 440 also includes a stop surface 444 sized and shaped to engage the first jaw 410.

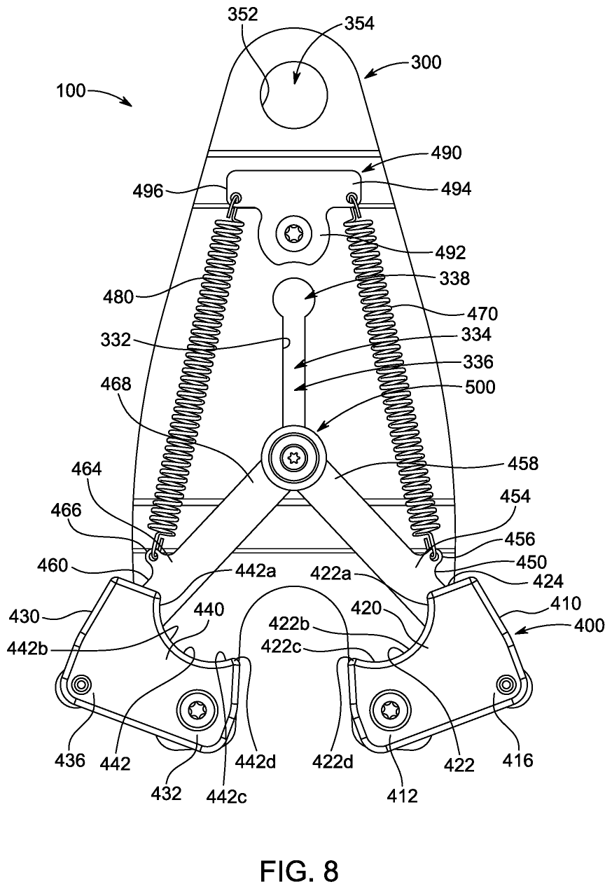

The first and second jaws 410 and 430 are sized and shaped to be (i) in closed positions as shown in FIGS. 1, 7, 9A, and 9B to securely hold a tool handle in the slots 214 and 324, (ii) moved to open positions as shown in FIGS. 2 and 8 to receive or release a tool handle, and (iii) moved back to the closed positions, as further explained below.

The biasing-member mount 490 is generally T-shaped and includes a lower section 492 and first and second outwardly extending upper sections 494 and 496. The first upper section 494 includes a cylindrical inner edge (not labeled) that defines a first spring receiving connection opening (not labeled) sized and shaped to enable an upper portion (not labeled) of the spring 470 to be connected to the first upper section 494 and thus the biasing-member mount 490. The second upper section 496 includes a cylindrical inner edge (not labeled) that defines a second spring receiving connection opening (not labeled) sized and shaped to enable an upper portion (not labeled) of the spring 480 to be connected to the second upper section 496 and thus the biasing-member mount 490. The lower section 492 includes a cylindrical edge (not labeled) that defines a cylindrical mount receiving opening 493 sized and shaped such that a tubular connector 498 can extend there through. The tubular connecter 498 and fasteners 499a and 499b fixedly connect the biasing-member mount 490 to the first and second plates 200 and 300. The biasing-member mount 490 is thus sized and shaped to facilitate mounting the respective upper portions of the springs 470 and 480 to the first and second plates 200 and 300. The employment of this biasing-member mount 490 eliminates the need to attach the springs 470 and 480 to the plates 200 and 300 for ease of construction (and assembly) and also centers the springs 470 and 480 relative to the plates 200 and 300.

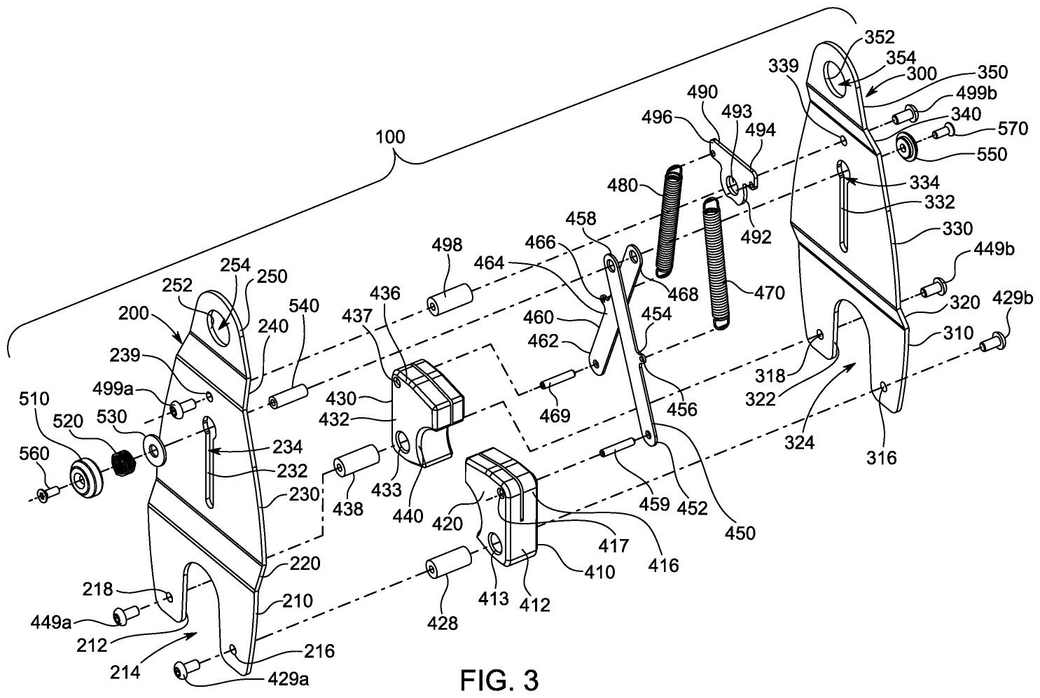

As best shown in FIGS. 3, 7, and 8, the first jaw actuator 450 includes a bottom section 452, a central section 454, and a top section 458. The bottom section 452 defines a pin receiving opening (not labeled) sized and shaped to receive the attachment pin 459 for pivotal attachment of the bottom section 452 to the connection section 416 of the jaw 410. The central section 454 includes an outwardly extending connection finger 456 that defines a spring member receiving opening (not labeled) sized and shaped to receive a lower portion of the spring 470 to enable attachment of the spring 470 to the first jaw actuator 450. The top section 458 defines a force-transfer member receiving opening (not labeled) sized and shaped to receive a force-transfer member 540 of the pushbutton locking assembly 500 (as described below). The top section 458 defines a force-transfer member receiving opening (not labeled) sized and shaped to receive a force-transfer member 540 of the pushbutton locking assembly 500 such that upward or downward movement of the force-transfer member 540 causes the respective upward or downward movement of the first jaw actuator 450.

Likewise, as best shown in FIGS. 3, 7, and 8, the second jaw actuator 460 includes a bottom section 462, a central section 464, and a top section 468. The bottom section 462 defines a pin receiving opening (not labeled) sized and shaped to receive the attachment pin 469 for pivotal attachment of the bottom section 462 to the connection section 436 of the jaw 430. The central section 464 includes an outwardly extending connection finger 466 that defines a spring member receiving opening (not labeled) sized and shaped to receive a lower portion of the spring 480 to enable attachment of the spring 480 to the second jaw actuator 450. The top section 468 defines a force-transfer member receiving slot (not labeled) sized and shaped to receive the force-transfer member 540 of the pushbutton locking assembly 500 (as described below). The top section 468 defines a force-transfer member receiving slot (not labeled) sized and shaped to receive the force-transfer member 540 of the pushbutton locking assembly 500 (as described below) such that upward or downward movement of the force-transfer member 540 causes the respective upward or downward movement of the first jaw actuator 460.

The first biasing member 470 and the second biasing member 480 are suitable springs respectively connected at their upper portions to the biasing-member mount 490 and at their lower portions to the first and second jaw actuators 450 and 460. The first biasing member 470 and the second biasing member 480 are respectively sized and shaped to bias the first and second jaw actuators 450 and 460 upwardly and thus bias the jaws 410 and 430 to their respective closed positions.

As best shown in FIGS. 3, 4, 5, and 6, the locking assembly 500 (sometimes referred to as a “pushbutton locking assembly” herein) includes a pushbutton 510, a biasing member 520 (here a compression spring), a spacer 530, a tubular force-transfer member 540, a blocker 550, and fasteners 560 and 570. The pushbutton 510 is connectable to the force-transfer member 540 by fastener 560 and the blocker 550 is connectable to the force-transfer member 540 by fastener 570.

More specifically, the pushbutton 510 includes an outer ring 512, an inner ring 514, and a center ring 516 connecting the outer ring 512 to the inner ring 514. Respective inner surfaces 512a, 514a, and 516a of the rings 512, 514, and 516 define an interior pocket 513 sized and shaped to receive an outer end (not labeled) of the spring 520. Respective inner surfaces of 514b and 516b of the rings 514 and 516 define a central fastener receiving channel (not labeled). The inner ring 514 includes a circular inner surface 514c sized and shaped to engage a first end 542 of the tubular force-transfer member 540. The outer ring 512 includes inner surfaces (not labeled) that form a cylindrical pocket (not labeled) sized and shaped to receive the spacer 530 when the pushbutton 510 is pushed in a direction D2 to unlock the pushbutton locking assembly 500 as described below.

The spacer 530 includes a cylindrical body having an inner surface sized and shaped to engage the outer surface (not labeled) of the central section 230 of the first plate 200 and an outer surface (not labeled) sized and shaped to be engaged by an inner end (not labeled) of the spring 520. The spacer 530 thus provides a base for the coil spring 520.

The coil spring 520 is sized and shaped to apply a biasing force in a direction D1 on the pushbutton 510 to keep the pushbutton locking assembly 500 in the locked configuration as described below.

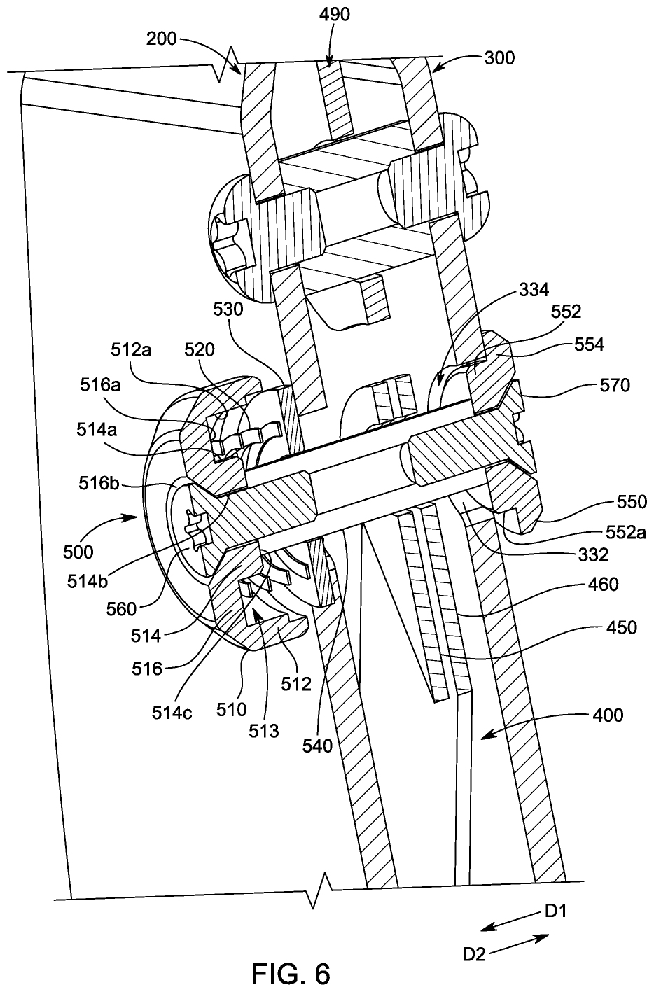

The blocker 550 includes an inner ring 552 and an outer ring 554 connected to the inner ring 552. As partially shown in FIG. 6, the inner ring 552 includes a cylindrical outer surface 552a sized and shaped to engage portions of the inner edge 332 of the second plate 300 that partially define the slot 334 in the second plate 300 to prevent the blocker 550 (and the entire locking assembly 500) from moving downwardly in the slots 234 and 334. FIG. 6 shows the blocker 550 in a position partially moved in the direction D2 from the fully engaged position where the outer surface 552a fully engages the inner edge 332.

The force-transfer member 540 includes a first end 542 and a second end 544. The first end 542 of the force-transfer member 540 defines a first channel (not labeled) sized and shaped to securely receive the first fastener 560. The second end 554 of the force-transfer member 540 defines a second channel (not labeled) sized and shaped to securely receive the second fastener 570. These secure connections can be provided by respective threads (not shown) or other suitable secure connection mechanisms. The force-transfer member 540 is sized and shaped to slide upwardly and downwardly in the elongated slots 232 and 332 defined by the first plate 200 and the second plate 300 as described below.

The locking assembly 500 is connectable to the first and plates 200 and 300 by inserting the tubular force-transfer member 540 through the circular locking section 236 of the pin-receiving slot 234 of the plate 200 and the circular locking section 336 of the pin-receiving slot 334 of the plate 300, attaching the blocker 550 to the second end 544 of the force-transfer member 540 using the second fastener 570, mounting the spacer 530 on the first end 542 of the force-transfer member 54, mounting the coil spring 520 on the first end 542 of force-transfer member 540, and attaching the pushbutton 510 to the first end 542 of the force-transfer member 540. When the locking assembly 500 is mounted to the first and second plates 200 and 300 in this manner, the coil spring 520 circumscribes the force-transfer member 540 and extends between the spacer 530 and the pushbutton 510. In that position, the coil spring 520 applies a biasing force in the direction D1 to the pushbutton 510 as well as to the connected tubular force-transfer member 540 and the blocker 550. In this position, the pushbutton 510 can be pushed in the direction D2 against the biasing force of the coil spring 520 to move the connected tubular force-transfer member 540 and blocker 550 in the direction D2 relative to the first and second plates 200 and 300.

The pushbutton locking assembly 500 can be in a locked configuration and in an unlocked configuration. In the locked configuration, as shown in FIGS. 1, 6, 7, 9A, and 9B, the inner ring 552 of the blocker 550 engages the inner edge 332 of the second plate 300 to prevent the force-transfer member 540 from moving downwardly in the slots 234 and 334. In this locked configuration, the pushbutton locking assembly 500 prevents the downward movement of the jaw actuators 450 and 460 and maintains the jaws 410 and 430 in their respective closed positions. The pushbutton locking assembly 500 is moved from the locked configuration to the unlocked configuration when the pushbutton 510 is pushed in the direction D2 against the biasing force of the coil spring 520 to move the connected tubular force-transfer member 540 and blocker 550 in the direction D2 relative to the first and second plates 200 and 300. This causes the inner ring 552 of the blocker 550 to dis-engage the inner edge 332 of the second plate 300 and thus enables the force-transfer member 540 to move downwardly in the slots 234 and 334.

The pushbutton locking assembly 500 can be in a retaining position and a release position. In the retaining position, as shown in FIGS. 1, 6, 7, 9A, and 9B, the pushbutton locking assembly 500 retains the gripping assembly 400 and specifically the first jaw 410 and the second jaw 430 in their respective closed positions. The pushbutton locking assembly 500 is moved from the retaining position to the release position after the pushbutton locking assembly 500 is moved into the unlocked configuration and the force-transfer member 540 is moved downwardly in the slots 234 and 334 to the bottom of the slots 234 and 334. In the release position, as shown in FIGS. 2, 8, and 9C, the pushbutton locking assembly 500 causes the gripping assembly 400 and specifically the first jaw 410 and the second jaw 430 to be in their respective open positions. In other words, the pushbutton locking assembly 500 enables the pushbutton locking assembly to move/be moved downwardly from the retaining position to the release position to cause the downward movement of the jaw actuators 450 and 460 and the outward rotation of the jaws 410 and 430 to release a tool handle from the jaws 410 and 430. In the lowermost unlocked configuration of the locking assembly 500, the jaws 410 and 430 are in fully open positions (as best shown in FIG. 8) and the jaws 410 and 430 have released the tool handle from the slots 214 and 324.

When the pushbutton locking assembly 500 is in the locked configuration as shown in FIGS. 1, 7, 9A, and 9B, the pushbutton 510 is pushable in the direction D2 against the bias of the coil spring 520 to cause the force-transfer member 540 to move in the direction D2 to cause the blocker 550 to move in the direction D2 and disengage from the second plate 300 to unlock the pushbutton locking assembly 500 from the second plate 300 and enable the pushbutton locking assembly 500 to move/be moved downwardly. Thus, to unlock the locking assembly 500, the operator can simply push in the pushbutton 510 in the direction D2 to cause the inner ring 514 of the pushbutton 510 to move the force-transfer member 540 in the direction D2 to cause the blocker 550 to move in the direction D2 and the locking ring 552 of the blocker 550 to disengage from second plate 300 (as partially shown in FIG. 6). This disengagement enables the locking assembly 500 to slide downwardly relative to the first plate 200 and the second plate 300 (and particularly enables the force-transfer member 540 to slide downwardly in the elongated slots 232 and 332 defined by the first plate 200 and the second plate 300). The downward movement of the force-transfer member 540 causes the downward movement of the top section 458 of the first jaw actuator 450 (against the bias of the spring 470) to cause outward movement of the bottom section of the first jaw actuator 450. This outward movement of the first jaw actuator 450 causes outward rotation of the top section 416 of the jaw 410 and rotation of the tool engaging surface 422 of the jaw 410. Likewise, downward movement of the force-transfer member 540 causes the downward movement of the top section 468 of the first jaw actuator 450 (against the bias of the spring 480) to cause outward movement of the bottom section of the second jaw actuator 460. This outward movement of the second jaw actuator 460 causes outward rotation of the top section 436 of the jaw 430 and rotation of the tool engaging surface 442 of the jaw 430.

When the pushbutton locking assembly 500 is in the release position as shown in FIGS. 2 and 8, to lock the locking assembly 500, the operator can simply slide the pushbutton 510 upwardly until the locking assembly 500 reaches the upper most position (thus reversing the above process). At that point, the coil spring 520 acts on the pushbutton 510 and specifically causes the pushbutton 510 to move in the direction D1. This causes the first connector 560 to move in the direction D1 and to pull the force-transfer member 540 in the direction D1 to cause the blocker 550 including the locking ring 552 to move in the direction D1 and thus move from the unlocked configuration to the locked configuration as shown in FIGS. 1, 7, 9A, and 9B. The locking assembly 500 is thus self-locking at that position.

It should be appreciated from the above that an operator can suspend the tool suspender 100 from a suspension device (such as chain 1500). The operator can then attach the suspender 100 to a handle 1100 of a tool by pushing in the pushbutton 510 (to unlock the pushbutton assembly 500) and sliding the pushbutton assembly 500 downwardly to the lowermost position at which point the pushbutton assembly 500 is in the release position. In this position, the jaws 410 and 420 are fully pivot outwardly to their respective open positions. The operator can then place tool suspender 100 on the handle 1100 such that the handle 1100 extends through the slots 214 and 324 and to the top of those slots. At this point, the suspender 100 rests on the tool handle 1100 with the top portions of the edges 212 and 322 that defines the slots 214 and 324 resting on the tool handle 1100. The operator can then slide the unlocked pushbutton assembly 500 upwardly to the uppermost position which is the retaining position. This causes the jaws 410 and 420 to pivot inwardly toward their respective closed positions. As the jaws 410 and 420 pivot inwardly the respective surfaces areas 422a and 422b of the first jaw 410 and the respective surfaces areas 442a and 442b of the second jaw 430 engage the handle 1100 and cause the handle to move downwardly in the slots 214 and 324 to the positions shown in 9A. When the pushbutton assembly 500 is in the retaining and unlocked configuration, the spring 520 biases the pushbutton assembly 500 into the locked configuration. Specifically, the biasing force in the direction D1 on the pushbutton 510 causes the pushbutton 510 to pull the force-transfer member 540 in the direction D1 to cause the force-transfer member 540 to pull the blocker 550 in the direction D1 to securely engage the second plate 300 to lock the pushbutton locking assembly 500 to the second plate 300 and prevent the pushbutton locking assembly 500 from being moving/being moved downwardly. In these locked and retained positions, the tool suspender 100 is locked on the handle 1100 and the tool 1000 with the jaws 410 and 420 engaging and gripping the handle 1100. In other words, the space between the jaws 410 and 430 when the locking assembly is in its retaining position is smaller than the width of the tool handle to prevent the tool handle from falling out of the slots 214 and 324. The tool 1000 can now be suspended. It should be appreciated that alternatively the operator can suspend the suspender 100 from a suspension device (such as chain 1500) after the suspender 100 is attached to a tool 1000.

This process is reversed when the operator wants to remove the suspender 100 from the tool 1000. Specifically, the operator can push in the pushbutton 510 (to unlock the pushbutton assembly 500) and slide the pushbutton assembly 500 downwardly from the retaining position to the release position. This causes the jaws 410 and 430 to pivot fully outwardly to their respective open positions. As the jaws 410 and 430 move from their closed positions to their open positions, the respective surface areas 422c and 442c including teeth 422d and 442d of the jaws 410 and 430 first move the handle 1100 upwardly in the slots 214 and 324 as shown in FIG. 9C, and then when the jaws 410 and 430 are in their fully open positions, the jaws 410 and 430 release the handle 1100 and the suspender 100 can be removed from the handle 1100 and the tool 1000.

In this example embodiment, the first plate 200, the second plate 300, the components of the gripping assembly 400, and the components of the pushbutton locking assembly 500 are all formed form metal, though one or more of these components can be made from any other suitable material in other embodiments.

1. A tool suspender comprising:
a first plate;
a second plate;
a gripping assembly between the first plate and the second plate and comprising first and second jaws supported by the first and second plates, the first jaw movable between a first closed position and a first open position and the second jaw moveable between a second closed position and a second open position; and
a locking assembly having a locked configuration in which the locking assembly prevents the first and second jaws from moving from their closed positions to their open positions and an unlocked configuration in which the locking assembly does not prevent the first and second jaws from moving from their closed positions to their open positions.

2. The tool suspender of claim 1, wherein the locking assembly comprises a biasing member biasing the locking assembly to the locked configuration.

3. The tool suspender of claim 1, wherein the locking assembly is operably connected to the gripping assembly such that, when the locking assembly is in the unlocked configuration, the locking assembly is slidable relative to the first and second plates from a retaining position to a release position to cause the first and second jaws of the gripping assembly to move from their respective closed positions to their respective open positions.

4. The tool suspender of claim 3, wherein the locking assembly is operably connected to the gripping assembly such that, when the locking assembly is in the unlocked configuration, the locking assembly is slidable relative to the first and second plates from the release position to the retaining position to cause the first and second jaws of the gripping assembly to move from their respective open positions to their respective closed positions.

5. The tool suspender of claim 1, wherein the first and second plates define aligned handle-receiving slots, and wherein the first and second jaws of the gripping assembly are pivotable relative to the handle-receiving slots between their respective open and closed positions.

6. The tool suspender of claim 5, wherein the first and second jaws are outwardly pivoted relative to the handle-receiving slots when in their respective open positions and inwardly pivoted relative to the handle-receiving slots when in their respective closed positions.

7. The tool suspender of claim 6, wherein the first and second jaws comprise respective gripping sections sized and shaped to engage a handle when the handle is positioned in the handle-receiving slots and to move the handle upwardly in the handle-receiving slots when the first and second jaws move from the inwardly pivoted positions to the outwardly pivoted positions.

8. The tool suspender of claim 7, wherein the gripping sections include teeth engageable with lower portions of the handle.

9. The tool suspender of claim 6, wherein the gripping assembly comprises one or more biasing members biasing the first and second jaws to their respective closed positions.

10. The tool suspender of claim 9, wherein the gripping assembly further comprises a first jaw actuator operably connecting the locking assembly to the first jaw and a second jaw actuator operably connecting the locking assembly to the second jaw.

11. The tool suspender of claim 10, wherein the first jaw actuator and the second jaw actuator are directly connected to the locking assembly.

12. The tool suspender of claim 10, wherein the first jaw and the second jaw each comprise a pivot section, a connection section, and a gripping section.

13. The tool suspender of claim 12, wherein the pivot section of the first jaw is pivotally connected to the first and second plates, the pivot section of the second jaw is pivotally connected to the first and second plates, the connection section of the first jaw is pivotally connected to the first jaw actuator, and the connection section of the second jaw is pivotally connected to the second jaw actuator.

14. The tool suspender of claim 12, wherein the locking assembly comprises a pushbutton, a biasing member, a force-transfer member, and a blocker, wherein the force-transfer member connects the pushbutton and the blocker, wherein the biasing member biases the pushbutton in a first direction such that the biasing member biases the locking assembly to the locked configuration.

15. The tool suspender of claim 14, wherein the pushbutton is movable in a second direction opposite the first direction against the biasing force of the biasing member to cause the force-transfer member and the blocker to move in the second direction to the locking assembly to the unlocked configuration.

16. The tool suspender of claim 15, wherein the blocker comprises a locking ring engageable with an inner edge of the second plate when the pushbutton locking assembly is in the locked configuration.

17. The tool suspender of claim 15, wherein the force-transfer member is fixedly connected to the pushbutton and the blocker.

18. The tool suspender of claim 15, wherein the force-transfer member is slidable in slots defined by the first and second plates.
